(19) United States
(12) Patent Application Publication
(10) Pub. No.: US 2005/0140547 A1
(43) Pub. Date: Jun. 30, 2005

(54) Method of, and apparatus for, determining position

(76) Inventor: Josi Rosenfeld, Hendon (GB)

Correspondence Address: PHILIPS INTELLECTUAL PROPERTY & STANDARDS, P.O. BOX 3001, BRIARCLIFF MANOR, NY, 10510, US

(21) Appl. No.: 10/508,285

(22) PCT Filed: Feb. 7, 2003
(86) PCT No.: PCT/IB03/00481

(30) Foreign Application Priority Data
Mar. 22, 2002 (GB) 0206766.8

(51) Int. Cl. G01S 3/02; G01S 5/02

(52) U.S. Cl. 342/417; 342/451

(57) ABSTRACT

A method of, and apparatus for, determining position, comprises a receiver (14) receiving a signal from a remote transmitter (22) whose position has to be determined. The Fourier transform of a power spectrum density of the received signal is determined and a check is made to see if a line-of-sight (LOS) signal is present. If so, a multipath mitigation technique is implemented to identify the LOS signal and once identified the position of the remote transmitter is determined by deriving the propagation time of the LOS signal. Current can be saved by inhibiting the multipath mitigation technique in the absence of detecting a LOS signal. In one embodiment the presence or absence of the LOS signal is determined by dividing the magnitude of the peak at zero frequency by the maximum magnitude of all the other peaks and if the answer is less than unity, LOS is not present.

The present invention relates to a method of, and apparatus for, determining position. The present invention has application in radio systems for locating/monitoring the positions of animate objects such as babies, people working in potentially hazardous areas and pets, such as dogs and cats, and inanimate objects such as articles in a warehouse.

Essentially a position determining system comprises a transmitter which is carried by the object whose position is to be determined and a receiver which receives the transmitted signal and determines the position of the object. However in determining the position accurately and with confidence the receiver has to be able to determine the presence of a line of sight (LOS) signal from amongst multipath reflected signals. If a received signal is processed in accordance with multipath mitigation techniques, without first determining if a LOS signal is present, then it may happen that the position computed is incorrect because it was based on a reflected signal as the LOS signal was not present due to it being blocked. Apart from lowering confidence in the position determining system there may tragic results in the delay in finding the object when in a hazardous situation. Also multipath mitigation techniques are computationally intensive which leads to a relatively high power consumption and can lead to a rapid discharging of batteries in a portable apparatus.

An object of the present invention is to improve on the confidence in determining position.

According to one aspect of the present invention there is provided a method of determining position, comprising receiving a signal from a remote transmitter, determining if a line-of-sight (LOS) signal is present and determining the position of the remote transmitter using the LOS signal.

According to a second aspect of the present invention there is provided a position determining apparatus comprising receiving means for receiving a positioning signal from a remote transmitter, means for determining if a line-of-sight (LOS) signal is present and means using the LOS signal for determining the position of the remote transmitter.

The present invention is based on recognition of the fact that if the test for the presence of a LOS signal is positive then additional tests are worth implementing. Such an additional test can be a multipath mitigation technique such as is disclosed in Performance Evaluation of the Multipath Estimating Delay Lock Loop, B. Townsend, D. J. R. van Nee, P. Fenton and K. van Dierendonck, Proc. of the Institute of navigation National Technical Meeting, Anaheim, Calif., USA, Jan. 18-22, 1995, pp 277 to 283. However in the event of a LOS signal not being detected, the receiver can inhibit proceeding with multipath mitigation techniques, thus saving power and optionally an alert can be energised indicating to a user that an acceptable signal has not been received.

A method of determining the presence of a LOS signal is based on an examination of the Fourier transform of the power spectrum density of a received signal. Such a technique is disclosed in the IEEE Transactions on Broadcasting, Vol. 44, No. 4, December 1998 pages 527 to 539 “Multipath Channel Characteristics Using Spectral Analysis of the Signal Power Density” by Steve Zeilinger, Tim Talty and Michael Chrysochoos. However this article does not disclose a simple but effective manner for determining if a LOS signal is present in a multipath signal and how to test for such a presence.

Statistical methods are known for detecting a LOS signal but are not regarded as being sufficiently reliable. One known technique assumes that if the probability distribution of multipath reflections is Rician then the LOS signal is present but if it is Rayleigh then the LOS signal is not present. The drawback to this method is that it relies on the fact that multipath signals are normally distributed over time, that is, they are innately random. This is an approximation that may not always be reliable.

The present invention will now be described, by way of example, with reference to the accompanying drawings, wherein:

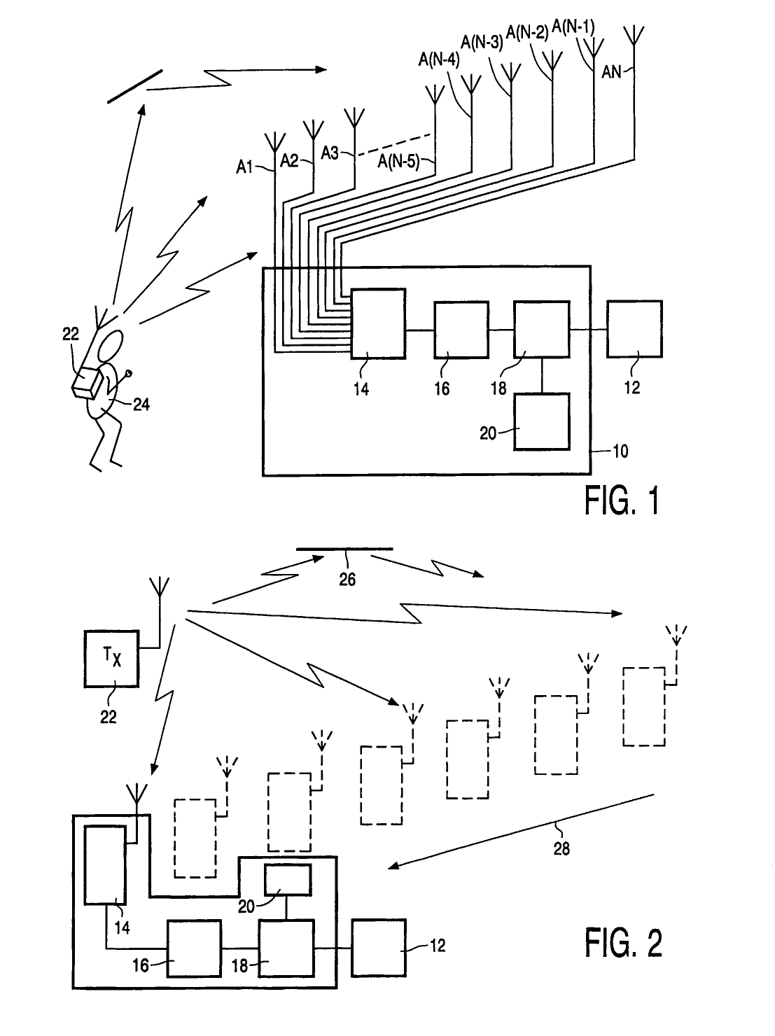

FIG. 1 is a block schematic diagram of an embodiment of a positioning system in which a receiver has a multiple antenna,

FIG. 2 is a block schematic diagram of an embodiment of a positioning system in which the receiver is mobile and moves at a constant speed,

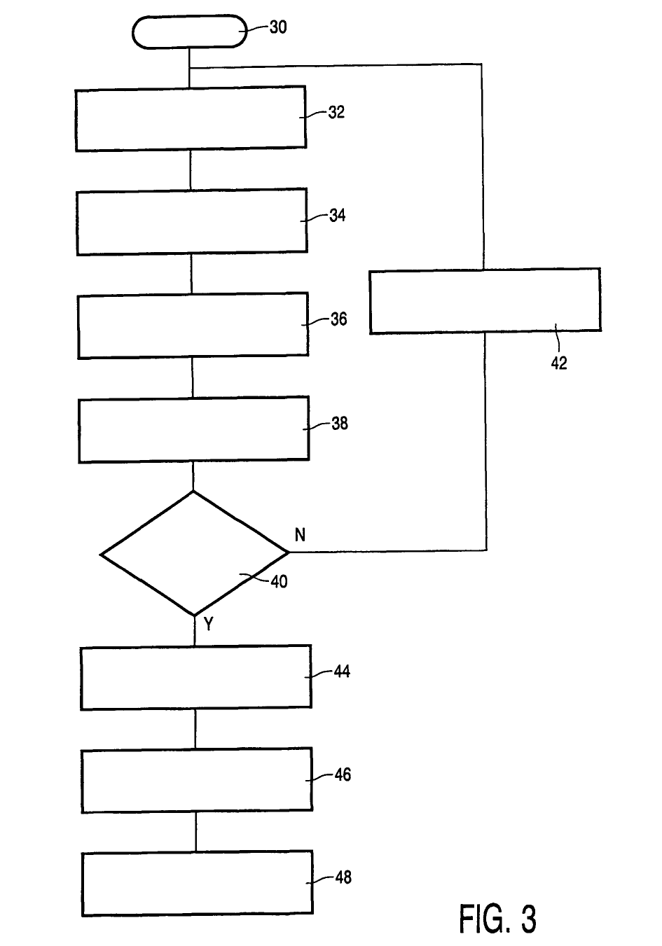

FIG. 3 is a flow chart showing the implementation of an embodiment of a method in accordance in accordance with the present invention, and

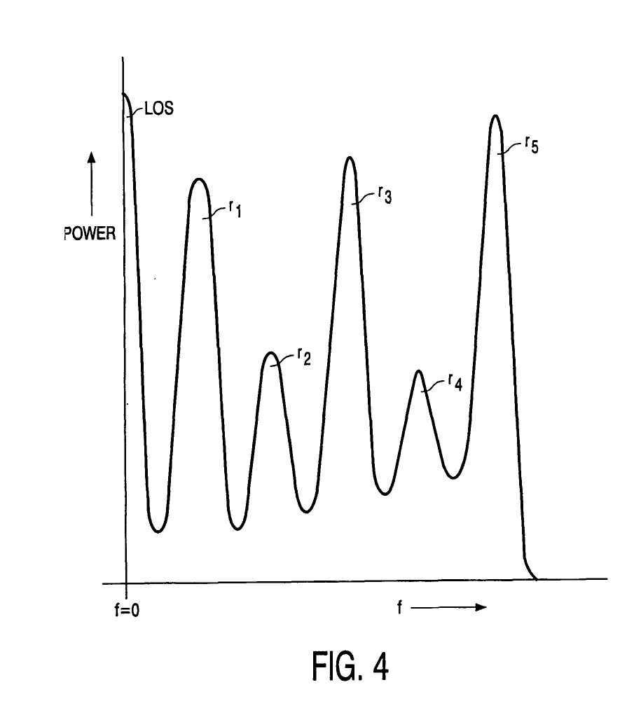

FIG. 4 is a diagram showing the Fourier transform of a signal power density of a multipath signal.

In the drawings the same reference numerals have been used to indicate corresponding features.

Referring to FIG. 1, the positioning system comprises a plurality of equally spaced antennas A1 to AN, where N is an integer having a value of the order of 20. The antennas A1 to AN are coupled to a positioning determining apparatus 10 having an output coupled to a display device 12. The apparatus 10 includes a multichannel receiver and correlator 14 having an output coupled to a demodulator 16. A demodulated signal is applied to a processor 18 which is operated in accordance with software held in a program ROM 20. The processor 18 is able to carry out various mathematical operations and in particular Fourier transforms. An output of the processor 18 is coupled to the display apparatus 12 which is able to display the position of a transmitter 22 carried by say a young child 24 playing freely in a recreation area whose parent(s) want to monitor where the child is at any instant. There are of course many other applications of the positioning system wherein the transmitter 22 is carried by or attached to an object or person to be monitored.

In operation the transmitted radiation comprising a direct sequence spread spectrum (DSSS) signal is received by the antennas A1 to AN directly as well as being reflected one or more times by reflectors, such as a reflector 26, which will cause radiation to be received subsequent to the receipt of the direct or line-of-sight (LOS) signal. The antennas A1 to AN are coupled to the receiver 14 which enables the received power at each point in space to be recorded. In order to be able to make an accurate position measurement it is necessary to detect whether the LOS signal has been received by the radio receiver 14. If it has not been detected in the received signal, the position measurement based on the multipath or reflected only radiation could be quite inaccurate.

In one embodiment of the method in accordance with the present invention a sufficient number of points are recorded in order to perform a valid Fourier transform on the delay power profile. Thus the power spectral density in k-space is obtained which yields the number and amplitudes of the specular reflections. By examination of the signal power spectral density there may be a peak centred at k=0 indicating a LOS signal being present together with peaks corresponding to multipath signals. In such a situation it is worth testing for the presence of a LOS signal by a process termed multipath mitigation technique described more fully in the Proc. of the Institute of Navigation National Technical Meeting identified in the preamble of this specification. This technique in itself consumes a relatively large current. The position of the transmitter 22 relative to the positioning determining apparatus is determined by measuring the propagation time which may be achieved by correlation using a measure and send technique disclosed in unpublished PCT patent application, IB02/03844 and U.S. patent application Ser. No. 10/252,499 (corresponding to British Patent Application 0125600.7; Applicant's reference PHGB 010173). In summary this technique comprises the steps of transmitting a timing signal from the first device to the second device at a time t1 relative to the local clock of the first device and measuring the time of arrival t2 of that signal at the second device relative to the local clock of the second device, transmitting a timing signal from the second device to the first device at a time t3 relative to the local clock of the second device and measuring the time of arrival t4 of that signal at the first device relative to the local clock of the first device, and assembling the values of t1, t2, t3 and t4 in one of the devices. The difference ΔClock between the local clocks of the first and second devices, the lack of synchronicity, may be readily determined in either one of the devices using the values t1, t2, t3 and t4. For example:

$$Δ Clock = \frac{t1 - t2 - t3 + t4}{2}$$

However if such a LOS peak is not detected then as a generality it is not worth trying to determine position as the risk of inaccuracy reduces confidence in the result.

FIG. 2 illustrates an alternative technique for deriving a sufficient number of points in order to perform a valid Fourier transform. In the illustrated embodiment a receiver having a single antenna is moved at a constant velocity as indicated by the arrow 28 and it records the received power at a number of points in time. Once a sufficient number of points have been recorded, a valid Fourier transform can be performed on the power spectrum density profile to yield the number and amplitudes of the specular reflections. A peak centred centred a k=0 indicates that the LOS signal is present and vice versa.

A process for determining position is illustrated by the flow chart shown in FIG. 3. Block 30 denotes the receiver 14 receiving a DSSS (Direct Sequence Spread Spectrum) signal which is demodulated as indicated by a block 34. A Fourier transform of the signal power density is obtained, denoted by a block 36. Block 38 denotes detecting for the presence of a LOS signal. Block 40 relates to checking if a LOS signal has been detected. If it has not been found (N) the flow chart proceeds to a block 42 which introduces an arbitrary time delay before repeating the operations indicated by the blocks 32 to 40.

If the answer from the block 40 is yes (Y) then in block 44 multipath mitigation techniques are used on the demodulated signal to determine the LOS signal and the multipath components. In block 46 the propagation time is determined by correlation. Thereafter in a block 48 the position of the transmitter 22 (FIGS. 1 and 2) is determined and displayed on the display device 12.

FIG. 4 illustrates a power spectrum density, that is frequency plotted against power. A number of peaks are shown which are due to the LOS signal at f=0 and the multipath or reflected components Γ₁ to Γ₅ at higher frequencies.

When there is no multipath, the average power density of the field of the signal measured over a locality (FIG. 1) or in the time domain (FIG. 2) will be constant. The Fourier transform of constant power yields a DC component, that is, a peak at zero frequency.

In order to test for LOS, some algorithmic tests will be described. In the spatial frequency, ω, domain there will be a number of spectral peaks as shown for example in FIG. 4. From the IEEE Transactions on Broadcasting article referred to in the preamble of the specification the formulae for the magnitude of these peaks is derived but for convenience they will be stated here as follows:

| Magnitude | Frequency |
|---|---|
| $K ( 1 + {\sum }_{n = 1}^{N} {Γ}_{n}^{2} )$ | 0 |
| KΓ₁ | ω₁ ∝ path difference to reflector 1 |
| KΓ₂ | ω₁ ∝ path difference to reflector 2 |
| KΓ₁ · Γ₂ | ω₃ ∝ path difference between reflector 1 and 2 |

In the above table of amplitude versus frequency component of spectral peaks K=πE₀²/η such that E₀ is the direct electric field, η is a magnetic field constant and Γₙ is the reflection coefficient. The form of K is not important for this algorithm. The magnitude of the DC component of the power spectrum density F(ω) when the LOS is present is given by:

$$F ( 0 ) = K ( 1 + {\sum }_{n = 1}^{N} {Γ}_{n}^{2} ) \qquad ( 1 )$$

when LOS is not present the DC component is in the form:

$$F ( 0 ) = K {\sum }_{n = 1}^{N} {Γ}_{n}^{2} \qquad ( 2 )$$

and the non-DC components are of the form:
F(ωₙ)=KΓₙ or (3)
F(ωₙ)=KΓₙΓₙ₊ⱼ where j≠0 (4)
The power density in the frequency domain is analysed for peaks. The total number of peaks for ω>0 that do not result from cross terms, that is, do not occur at a beat frequency of the other peaks, are the total number N of reflections. The magnitude of these peaks are recorded as Γ₁, Γ₂, . . . , Γₙ. Further to this, the maximum peak should be identified, viz. the peak Γ₅ in FIG. 4 which is of the form Fₘₐₓ=KΓₘₐₓ.

From equation (1) the ratio for LOS being present is given by:

$$\begin{matrix}ϕ = \frac{Mag . of D C Component}{Mag . of Reflected Peaks} & ( 5 ) \\ = \frac{1 + {\sum }_{n}^{N} {Γ}_{n}^{2}}{{Γ}_{n}} where {Γ}_{n} < 1 ∀ n & ( 6 )\end{matrix}$$

From Eqn (2) if the LOS is not present it is of the form:

$$ϕ = \frac{{\sum }_{n}^{N} {Γ}_{n}^{2}}{{Γ}_{n}} where {Γ}_{n} < 1 ∀ n \qquad ( 7 )$$

The ratio form is used as K is then eliminated.

From Eqn (6) and Eqn (7) the lower bounds for the LOS and no LOS case, respectively, can be determined as follows:

$$\begin{matrix}ϕ = \frac{1 + {\sum }_{n}^{N} {Γ}_{n}^{2}}{{Γ}_{n}} \geq \frac{{Γ}_{max}^{2} + 1}{{Γ}_{n}} & ( 8 ) \\ \geq \frac{1 + {Γ}_{max}^{2}}{{Γ}_{max}} = \frac{1}{{Γ}_{max}} + {Γ}_{max} > 1 & ( 9 )\end{matrix}$$

In the no LOS case

$$\begin{matrix}ϕ = \frac{{\sum }_{n}^{N} {Γ}_{n}}{{Γ}_{n}} \geq \frac{{Γ}_{max}^{2}}{{Γ}_{max}} & ( 10 ) \\ \geq {Γ}_{max} < 1 & ( 11 )\end{matrix}$$

If the value of φ by taking the ratio specified in equation (5) is found to be less than 1, that is, φ<1, it can be shown that

$$ϕ \neq \frac{1 + {\sum }_{n}^{N} {Γ}_{n}^{2}}{{Γ}_{n}}$$

and hence LOS signal is not present and there is no justification to apply say a multipath mitigation technique to the received signal.

To implement this test all that is required is to simply divide the magnitude of the peak at zero frequency with the maximum magnitude of all the other peaks, that is, Fₘₐₓ. This test will successfully discern the absence of LOS, that is when there is no LOS φ will always be less than 1.

Other algorithmic tests for LOS include (1) determining all the reflection coefficients Γₙ and the value of N from the received data and (2) applying an upper bound test. However each of these tests require the value of K to be determined.

This may be done by considering the magnitude of two reflection peaks F₁=KΓ₁ and F₂=KΓ₂ and the magnitude of their beat frequency F₃=KΓ₁Γ₂. Substituting these values into the following equation:

$$K = \frac{{F}_{1} \cdot {F}_{2}}{{F}_{3}} = \frac{K {Γ}_{1} \cdot K {Γ}_{2}}{K {Γ}_{3}}$$

Since the magnitudes of F₁, F₂ and F₃ can be determined, K can readily be calculated.

Reverting to the test (1) mentioned above all the reflection peaks, excluding the beat frequency peaks, are observed and their amplitudes Aₙ are noted and the LOS is determined by calculating the DC component, say a value “H”.

From equation (3) above we know that:

$${Γ}_{n} = \frac{{A}_{n}}{K} .$$

If LOS is present:

$$\begin{matrix}K ( 1 + {ΣΓ}_{n}^{2} ) = K ( 1 + \frac{1}{{K}^{2}} {Σ}_{n} {A}_{n}^{2} ) \\ = K + \frac{1}{K} {Σ}_{n} {A}_{n}^{2} = value C\end{matrix}$$

If LOS is not present:

$$K ( {ΣΓ}_{n}^{2} ) = \frac{1}{K} {\sum }_{n} {A}_{n}^{2} = value E$$

The test is whether the value of the DC peak, H, is equal to the value C or the value E. If H=E, LOS is not present and if H=C, LOS is present.

The upper bound test (2) is based on the case when LOS is present is given by:

$$\frac{1 + {\sum }_{n}^{N} {Γ}_{n}^{2}}{{Γ}_{n}} ≦ \frac{1}{{Γ}_{max}} + {NT}_{max}$$

When LOS is not present:

$$\frac{{\sum }_{n}^{N} {Γ}_{n}^{2}}{{Γ}_{n}} ≦ {NΓ}_{max}$$

By determining the number N of reflection peaks from the spectral analysis and Γₘₐₓ from the data will enable the upper bounds to be calculated.

The maximum peak of the data can be determined form the equation;

$${Γ}_{max} = \frac{{F}_{max}}{K}$$

where Γₘₐₓ and K have been determined as described above.

The value of the upper bound which is NΓₘₐₓ for no LOS and 1/Γₘₐₓ+NΓₘₐₓ for LOS present. If

$$\frac{Mag . of D . C . Component}{{F}_{max}} > N {Γ}_{max}$$

then the LOS is present, if <NΓₘₐₓ the test is inconclusive.

In the present specification and claims the word “a” or “an” preceding an element does not exclude the presence of a plurality of such elements. Further, the word “comprising” does not exclude the presence of other elements or steps than those listed.

From reading the present disclosure, other modifications will be apparent to persons skilled in the art. Such modifications may involve other features which are already known in the design, manufacture and use of apparatus for determining position and component parts therefor and which may be used instead of or in addition to features already described herein. Although claims have been formulated in this application to particular combinations of features, it should be understood that the scope of the disclosure of the present application also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

1. A method of determining position, comprising receiving a signal from a remote transmitter, determining if a line-of-sight (LOS) signal is present and determining the position of the remote transmitter using the LOS signal.

2. A method as claimed in claim 1, characterised by deriving the Fourier transform of a power spectrum density of the received signal, checking for the presence of a DC value at zero frequency, if so, implementing a multipath mitigation technique to identify the LOS signal.

3. A method as claimed in claim 2, characterised by responding to is the absence of the LOS signal by inhibiting the multipath mitigation technique.

4. A method as claimed in claim 1, characterised by deriving the Fourier transform of a power spectrum density of the received signal and by determining the presence or absence of the LOS signal by dividing the magnitude of the peak at zero frequency by the maximum magnitude of all the other peaks and if the answer is less than unity, LOS is not present.

5. A method as claimed in claim 1, characterised by deriving the Fourier transform of a power spectrum density of the received signal and by determining the presence or absence of the LOS signal by determining the lower bounds of a ratio
$$ϕ = \frac{Mag . of D . C . Component}{Mag . of Reflection Peaks}$$
if φ is less than unity, LOS is not present.

6. A method as claimed in claim 1, characterised by deriving the Fourier transform of the power spectrum density of the received signal, noting the amplitudes of all the reflection peaks, calculating a DC component and determining if the calculated value corresponds to a value associated with LOS being present.

7. A position determining apparatus comprising receiving means for receiving a positioning signal from a remote transmitter, means for determining if a line-of-sight (LOS) signal is present and means using the LOS signal for determining the position of the remote transmitter.

8. A position determining apparatus as claimed in claim 7, characterised by means for deriving the Fourier transform of a power spectrum density of the received signal, means for determining if a peak is present in the power spectrum density at zero frequency, and means for implementing multipath mitigation to identify a line-of-sight (LOS)

9. An apparatus as claimed in claim 8, characterised by means responsive to a LOS signal being absent for inhibiting the multipath mitigation means.

10. An apparatus as claimed in claim 7, characterised in that the means for determining if a peak is present at zero frequency comprises means for deriving the Fourier transform of a power spectrum density of the received signal, means for determining the quotient of the magnitude of a peak at zero frequency divided by the maximum magnitude of all the other peaks and means for determining if the answer is less than unity, thereby indicating that LOS is not present.

11. An apparatus as claimed in claim 7, characterised in that the means for determining if a peak is present at zero frequency comprises means for deriving the Fourier transform of a power spectrum density of the received signal, means for determining the lower bounds of a ratio
$$ϕ = \frac{Mag . of D . C . Component}{Mag . of Reflection Peaks}$$
if φis less than unity, LOS is not present.

12. An apparatus as claimed in claim 7, characterised by means for deriving the Fourier transform of the power spectrum density of the received signal, means for noting the amplitude of all the reflection peaks, excluding the beat frequency peaks, and means for calculating a DC component and for determining if the calculated value corresponds to a value associated with LOS being present.
